(19) United States
(12) Patent Application Publication
(10) Pub. No.: US 2021/0005921 A1
(43) Pub. Date: Jan. 7, 2021

(54) ALUMINUM CAN WITH MULTI-THICKNESS WALL FOR LITHIUM-ION CELL

(71) Applicant: NIO USA, Inc., San Jose, CA (US)

(72) Inventors: Marc W. Juzkow, Livermore, CA (US); Alexander J. Smith, Saratoga, CA (US)

(21) Appl. No.: 16/459,355

(22) Filed: Jul. 1, 2019

(51) Int. Cl. H01M 10/054; H01M 10/0585; H01M 4/36; H01M 4/13

(52) U.S. Cl. CPC H01M 10/054; H01M 10/0585; H01M 2004/027; H01M 4/13; H01M 4/366

(57) ABSTRACT

An energy storage cell that includes a positive electrode including a positive electrode active material in electrically conductive contact with a positive electrode current collector; a negative electrode including a negative electrode active material in electrically conductive contact with a negative electrode current collector; an electrically insulative and ion conductive medium in ionically conductive contact with the positive electrode and the negative electrode, where the electrically insulative and ion conductive medium comprises an electrically insulating porous layer and an electrolyte; and an outer can containing the positive electrode, the negative electrode and the electrically insulative and ion conductive medium, where a wall of the outer can has a variance in thickness.

### FIELD

The present disclosure is generally directed to energy storage devices, in particular, toward batteries and battery modules for electric vehicles.

### BACKGROUND

In recent years, the demand for high performance batteries has increased, driven in part by the increasingly large number of portable consumer electronics products and growing needs of batteries for hybrid and fully electric vehicles. Lithium-ion cells are found in many applications requiring high energy and high power densities, as they can provide high volumetric and gravimetric efficiency in single and multi-cell battery packs. Such battery packs can be used in many applications, for example in portable electronic devices and in hybrid and fully electric vehicles.

Increasing the gravimetric energy density of a lithium-ion cell by increasing the energy of the cell in comparison to the weight of the cell is advantageous in order to improve the performance of the cell. Increases in gravimetric energy density have conventionally been difficult to achieve. Reasons for this include the fact that it can be difficult to decrease the weight of lithium-ion cells.

Therefore, there is a need to develop designs and methods for improving the gravimetric energy density of electrochemical cells. The present disclosure satisfies these and other needs.

### BRIEF DESCRIPTION OF THE DRAWINGS

FIG. 1 shows a side view of a cell in accordance with embodiments of the present disclosure;

FIG. 2 shows a cross-sectional side view of a header of a cell in accordance with embodiments of the present disclosure;

FIG. 3 shows a cross-sectional side view of a method of laser welding components of a cell in accordance with embodiments of the present disclosure;

FIG. 4A shows a cross-sectional side view of thicknesses of a top side of a can in accordance with embodiments of the present disclosure;

FIG. 4B shows a cross-sectional side view of thicknesses of a can in accordance with embodiments of the present disclosure;

FIG. 4C shows a cross-sectional side view of crimping of a can in accordance with embodiments of the present disclosure;

FIG. 5 shows a cross-sectional side view of thicknesses of a can prior to crimping of a can in accordance with embodiments of the present disclosure;

FIG. 6 shows methods for forming aluminum cans with multi-thickness walls in accordance with embodiments of the present disclosure; and

FIG. 7 shows methods of manufacturing lithium-ion cells using aluminum cans with multi-thickness walls in accordance with embodiments of the present disclosure.

### DETAILED DESCRIPTION

Embodiments of the present disclosure will be described in connection with electrochemical cells, and in some embodiments, the construction, structure, and arrangement of components making up electrochemical cells and the methods of manufacturing electrochemical cells. In some embodiments, the lithium-ion cells as disclosed herein can have negative electrodes including negative electrode active materials such as hard carbon, graphite, silicon compounds, or a combination thereof, and positive electrodes including positive electrode active materials whose charge storage and discharge mechanisms involve the de-insertion and insertion of Li ions, respectively. In some embodiments, this is accomplished by intercalation and de-intercalation in and out of a layered, olivine or spinel structure.

The term “positive electrode” refers to one of a pair of rechargeable lithium-ion cell electrodes that under normal circumstances and when the cell is fully charged will have the higher potential than the other electrode versus a lithium reference electrode. This terminology is retained to refer to the same physical electrode under all cell operating conditions even if such electrode temporarily (e.g., due to cell over discharge) is driven to or exhibits a potential below that of the other (the negative) electrode.

The term “negative electrode” refers to one of a pair of rechargeable lithium-ion cell electrodes that, under normal circumstances and when the cell is fully charged, will have the lower potential than the opposite electrode versus a lithium reference electrode. This terminology is retained to refer to the same physical electrode under all cell operating conditions even if such electrode is temporarily (e.g., due to cell over discharge) driven to or exhibits a potential above that of the other (the positive) electrode.

In electrochemical cells, it is generally advantageous to increase the gravimetric energy density of the cell as this value directly translates to the gravimetric energy density of lithium-ion battery modules and battery packs. The embodiments disclosed herein also apply to Lithium-ion cells and Lithium metal cells. Lithium-ion electrochemical cells are made up of various components that include a positive electrode and at least one positive tab, a negative electrode and at least one negative tab, an electrolyte, separator film, and a can, within which the components are inserted and a header (e.g., at the top of the can) is used to seal the cell. In conventional lithium-ion cells, nickel-plated mild steel is used for the can but it is heavier than other possible can material options. Decreasing the weight of the can directly translates into higher gravimetric energy density of the cell.

In cylindrical cells, the standard design has the negative electrode tab resistance welded to the bottom of the inside of the can, which results in a negative can potential. The negative tab is typically nickel, copper or a combination of nickel and copper. Welding this negative tab to the nickel-plated mild steel can be accomplished consistently with a resistance spot welder.

In standard lithium-ion cells, the metal cans are held at the negative electrode potential versus Li/Li+. It is thus important to choose materials that are stable and will not corrode, react, or alloy at the negative electrode potential. Nickel-plated mild steel is stable and does not corrode, react, or alloy at the negative potential of the electrochemical cell. However, one way to obtain a lighter weight cell is to use a material for the can that lighter than nickel-plated mild steel, such as aluminum.

Aluminum is one choice for a lighter weight can because it is less dense than mild steel. However, in standard lithium-ion cylindrical cell designs, aluminum is not used as a material for a can due to issues with stability and strength. For example, aluminum is only stable at the potential of the positive electrode and can alloy with lithium when at a lower potential, typically below about 0.2V or below about 0.3V vs. the Li/Li+ potential. If aluminum is held at a low negative potential (e.g., less than about 0.3V versus Li/Li+) then lithium would alloy with the aluminum can and lead to unstable precipitates, thereby decreasing corrosion resistance primarily at the grain boundaries, and decreasing the fracture strength. In addition, aluminum is not as strong as nickel plated steel and a strong crimp strength requires a strong can material. Because of the difference in strength, a certain thickness of aluminum will not be as strong as the same or a similar thickness of nickel-plated steel. These issues may cause the can to fail. This can be especially dangerous when the interior pressure of a cell increases (e.g., due to the generation excessive gas in a short period of time) because the opening of vents in the cell may not release the pressure quickly enough and the entire header can be expelled if the crimp strength is insufficient. Thus, problems that may occur when using a different material for the can (e.g., aluminum), is decreased safety. These problems may also be especially dangerous when the cells are arranged within a battery module as explained below.

A battery module comprises individual cells that are arranged within a structure, generally resembling a honeycomb or matrix. If one or more of the cells cannot vent properly, overheating or cell short circuiting may occur. In such a scenario, thermal runaway is a possibility, and the heat generated from the damage to one or more cells may spread to other cells, thereby causing additional problems, such as increased cell failure and dangerous conditions for the battery. Also, if a cell header is expelled, this may damage other cells within the battery module and lead to other issues such as increased cell failure and dangerous conditions for the battery. These are some of the electrochemical reasons why aluminum cans are not used in the standard lithium-ion cylindrical cell design.

Various embodiments in the present disclosure advantageously increase the gravimetric energy density of lithium-ion cells by providing cells that can use an outer can design that is advantageously lighter-weight. Can designs of the present disclosure include cans having one or more variances in wall thicknesses. For example, a can may be formed using a drawing and ironing technique that adjusts the thicknesses of the walls of the can. Thus, the bottom and walls of the can may vary in thickness and be thinner in portions where less strength is required. In various aspects, the walls of the can may be thicker at a portion that connects (e.g., is crimped) to a header of the cell.

As used herein, the terms “wall” and “walls” of the can are interchangeable and refer to a continuous structure, or a portion of a continuous structure, that forms the enclosure of the can including a bottom surface and one or more side surfaces. The walls of the can may be any shape when forming the can; for example, they may be flat prior to being shaped to form the enclosure forming the can.

Various embodiments in the present disclosure advantageously increase the gravimetric energy density of lithium-ion cells by providing cells that can use a can material that is lighter-weight than nickel-plated mild steel while avoiding corrosion issues. Increases of more than about 7 percent in the gravimetric energy density of cylindrical lithium-ion cells (e.g., 18650 cell (18 mm diameter×65 mm length) and 21700 cell (21 mm diameter×70 mm length) lithium-ion cells) can be achieved when using aluminum as the can material instead of nickel-plated mild steel, and more than about 3 percent in the gravimetric density when using titanium as the can material instead of nickel-plated steel.

Various embodiments relate to an electrochemical cell having a positive electrode comprising a positive electrode active material in electrically conductive contact with a positive electrode current collector, a negative electrode comprising a negative electrode active material in electrically conductive contact with a negative electrode current collector, an electrically insulative and ion conductive medium in ionically conductive contact with the positive electrode and the negative electrode, where the ionically conductive medium comprises an electrically insulating porous layer and an electrolyte, and an outer can containing the positive electrode, the negative electrode and the electrically insulative and ion conductive medium, where a wall of the outer can has a variance in thickness.

Various embodiments in the present disclosure advantageously increase the gravimetric energy density of lithium-ion cells by providing cells that can use a can having a variance in thickness. In some aspects, conventional designs of cells may be used with a can advantageously having a variance in thickness. The term “variance in thickness” includes one or more variances of thicknesses that may be any size, shape, and/or pattern, including uniform and non-uniform shapes and patterns.

The variance in thickness of the can may include where a thickness of the top part of the outer can (e.g., a portion of the can that is adjacent to the header and/or crimped to the header) is greater than a thickness of a middle and bottom ends of the outer can, and a thickness of the bottom part of the outer can may also be thicker than the middle and bottom sides of the outer can. An increased thickness at the top end of the can may advantageously provide for a stronger crimp between the can and the header. An increased thickness at the bottom part of the can may advantageously provide strength to limit bulging from internal can pressure. A thinner section of the middle and bottom walls will lower the can mass and may advantageously increase the gravimetric energy density of the lithium-ion cell. Although the walls of the can may vary in thickness, the inner diameter of the can may be constant. For example, an inner diameter of the top part of the outer can may be substantially the same throughout the can height from the top to the bottom, so that it is substantially the same as an inner diameter of the bottom part of the outer can. In some aspects, this may ensure that the can will fit properly around the components being placed inside of the can (e.g., the positive electrode, the negative electrode and the electrically insulative and ion conductive medium) when manufacturing the cell. Thus, an outer diameter of the can may vary as an inner diameter of the can stays constant. In some aspects, the inner diameter of the can may be constant for only a portion of the can height; for example, the inner diameter may be greater at the top opening of the can where the components are placed inside. A wider top opening allows for increased margin when inserting the electrode and separator winding; and minimize the possibility of tearing the outer electrode and/or separator layers.

The variance in thickness of the can may be based on desired properties of the can, such as a desired higher strength where the can is crimped to the header. In various embodiments, the variance in thickness of the can may be only at the bottom end of the can, where the walls at the bottom end of the can are thicker than the other walls of the can. In some embodiments, only the bottom end of the can (e.g., the circular shaped bottom of the can opposite the header) may be thicker than the walls of the can (e.g., the cylindrical sides of the can). A thicker bottom end of the can may advantageously increase the strength of the bottom end of the can (e.g., due to a lower dimensional strength of the flat bottom end versus the cylindrical sides). A thickness, or variation(s) in thickness of the bottom end of the can may be based on a desired strength of the bottom end of the can.

The electrochemical cell may have the negative electrode electrically connected to a header of the electrochemical cell. In some aspects, the negative electrode may be welded (e.g., laser welded or resistance welded) to a weld disc in the header. Thus, components of the header may have a negative potential, including the top cap of the header. The electrochemical cell may have the positive electrode electrically connected to the outer can (e.g., a bottom of the outer can). The positive electrode may be connected to the outer can by welding from an outside of the can while using a rod to hold the positive electrode against an interior bottom of the can, for example. Thus, the can may have a positive potential.

The outer can of the cell may include substantially a metal composition comprising one or more of aluminum or an alloy thereof and titanium or an alloy thereof. The metal composition of the can may include various grades and alloys of aluminum and/or titanium, including but not limited to a 3004 alloy of aluminum, 5000 series of aluminum alloys, and/or 6000 series of aluminum alloys. The 5000 series of aluminum alloys may advantageously provide a greater strength. The 6000 series of aluminum alloys may be advantageous because they can be extruded with greater ease and more economically than other alloys.

The density of the material(s) of the outer can may be typically from about 5 g/cm³ to about 1.6 g/cm³, more typically from about 4.6 g/cm³ to about 1.7 g/cm³, or more typically from about 4.506 g/cm³. The density of the outer can may also be typically from about 1.8 g/cm³ to about 4.4 g/cm³, more typically from about 1.9 g/cm³ to about 4.2 g/cm³, more typically from about 2 g/cm³ to about 4 g/cm³, more typically from about 2.1 g/cm³ to about 3.8 g/cm³, more typically from about 2.2 g/cm³ g/cm³ to about 3.6 g/cm³, more typically from about 2.3 g/cm³ to about 3.4 g/cm³, more typically from about 2.4 g/cm³ to about 3.2 g/cm³, more typically from about 2.5 g/cm³ to about 3 g/cm³ or more typically from about 2.6 g/cm³ to about 2.8 g/cm³, or more typically about 2.7 g/cm³.

The outer can of the cell may include substantially a metal composition with a density less than steel (e.g., less than about 7.75 g/cm² to about 8.05 g/cm²) or a density less than mild steel (e.g., less than about 7.85 g/cm²). Thus, aluminum or an aluminum alloy may be used, with a density of about 2.7 g/cm², or titanium or a titanium alloy may be used, with a density of about 4.51 g/cm². Advantageously, even if the can walls of the present embodiments are thicker (even slightly thicker) than those of conventional cans (e.g., mild steel cans), the total can mass will be lighter, which results in an improved gravimetric energy density. In particular, an aluminum (or aluminum alloy) can may have thicker walls (or portions of walls) than a conventional can; however, aluminum has a lower tensile strength and so the thickness may improve strength of the aluminum can while still providing for an improved gravimetric energy density due to the reduced can mass.

Various configurations and components may be used to electrically isolate the electrodes from the interior components of the can. For example, an electrically insulative tape may be adhered on both sides of an exposed portion of the negative electrode tab adjacent to where the negative electrode is electrically connected to the header. Also, an electrically insulative coating may be in contact with an exposed portion of the negative electrode tab adjacent to where the negative electrode is electrically connected to the header. The electrically insulative material may be any material or combination of materials that is electrically insulative, including an epoxy coating.

Various embodiments relate to methods of manufacturing an electrochemical cell that include forming a positive electrode comprising a positive electrode active material in electrically conductive contact with a positive electrode current collector; forming a negative electrode comprising a negative electrode active material in electrically conductive contact with a negative electrode current collector; inserting the positive electrode, the negative electrode, and an electrically insulative and ion conductive medium into an outer can where the ionically conductive medium comprises an electrically insulating porous layer and an electrolyte and where the electrically insulative and ion conductive medium is in ionically conductive contact with the positive electrode and the negative electrode. The wall of the outer can has a variance in thickness and the outer can is crimped to a header.

The methods may include ironing the wall of the outer can to obtain the variance in thickness prior to the inserting the positive electrode, the negative electrode, and the electrically insulative and ion conductive medium. The can may be shaped using a drawing/forming technique and by ironing the walls of the can to adjust the thicknesses of the walls to obtain the desired variance in thickness; for example, thicker portions at the top and bottom of the can with a thinner portion in the middle of the can. Other methods may be used to form a can having a variance in thickness, and the methods are not limited to the description provided herein.

The outer can may be attached to the header in any manner, including a crimping process. The crimping process to crimp the outer can to the header can be a progressive crimping process. Multiple dies may be used with grooving (where the tools to perform the grooving may be different than the dies for the crimping process) done prior to filling the electrolyte, then the negative electrode tab being welded to the weld plate in the header. The header may then be placed on the shelf generated by the grooving process and the header and outer can may be crimped to seal them together. As described herein, any variance in thickness may be used, including those that advantageously decrease the weight of the cell, and the variance in thickness may advantageously be based on a desired strength for the crimp between the outer can and the header.

The methods may include assembling other components of the cell as described herein, including electrically connecting the negative electrode to the header. In certain aspects, the polarities of the cell may be switched (e.g., with the header of the cell being at a negative potential and the can of the cell being at a positive potential) from what is conventional. The method can further include welding the negative electrode tab to the weld disc in the header via laser welding or resistance welding, for example, and welding the positive electrode tab to the outer can at an interior surface of the bottom of the can by applying a laser to the outside of the can while using a rod to push the positive tab onto the bottom of the can from the inside of the can. As discussed herein, the outer can may include substantially a metal composition comprising one or more of aluminum or an alloy thereof and titanium or an alloy thereof.

Various embodiments relate to a battery for an electric vehicle, including a plurality of battery modules electrically interconnected with one another, wherein each battery module of the plurality of battery modules includes a plurality of energy storage cells. Each of the energy storage cells may include a positive electrode comprising a positive electrode active material in electrically conductive contact with a positive electrode current collector; a negative electrode comprising a negative electrode active material in electrically conductive contact with a negative electrode current collector; an electrically insulative and ion conductive medium in ionically conductive contact with the positive electrode and the negative electrode, wherein the ionically conductive medium comprises an electrically insulating porous layer and an electrolyte; and an outer can containing the positive electrode, the negative electrode and the electrically insulative and ion conductive medium, wherein a wall of the outer can has a variance in thickness.

Embodiments of the present disclosure will be described in connection with electrical energy storage devices, and in some embodiments, in connection with the construction and structure of components making up a battery module.

Although embodiments described herein may be described with respect to an electric vehicle or automobile, the present disclosure is not so limited. Various embodiments of the present disclosure can apply to any type of machine using a battery, for example mobile machines including but not limited to, vertical takeoff and landing vehicles, aircraft, spacecraft, watercraft, and trains, among others.

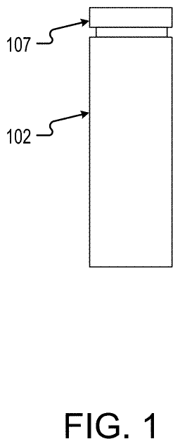

FIG. 1 shows a side view of a cell 100 in accordance with embodiments of the present disclosure. The cell 100 has a can 102 with a header 107. The cell 100 may include a can 102 that extends around the bottom end of the cell such that it continuously encloses the cell from the bottom end of the cell through the sides of the cell up to where the can 102 meets the header 107.

As used herein, the term “top end” (also referred to as “top portion” and “top part”) refers to a portion of the cell that is closer to the header 107. The term “bottom end” (also referred to as “bottom portion” and “bottom part”) refers to a portion of the cell that is further from the header 107. Thus, the top end is opposite to the bottom end, and the cell's height is the total distance between the lowermost bottom end and the uppermost top end, assuming the cell is oriented with the height being in a vertical direction, as shown in FIG. 1. The middle of the cell (also referred to as “middle part”, “middle portion” or “middle sides”) is between the top end and the bottom end and bottom sides.

In embodiments of the present disclosure, the cell 100 can use a conventional header design. Conventional headers of lithium-ion cells can utilize a mechanical safety device and a positive thermal coefficient (PTC) device. A mechanical device called a Current Interrupt Device (CID) can be used. The CID device may have functions that include overcharge protection, overvoltage protection and protection against other abusive conditions that lead to increased internal pressure. Increased internal pressure can cause a disc (sometimes referred to as a vent disc) to move and separate from another disc (sometimes referred to as a weld disc). Also, indirectly high temperature can lead to electrolyte decomposition, gas generation and increased internal cell pressure. The movement of the vent disc can break the mechanical connection and disconnect the negative header of the cell from the negative electrode, thereby permanently interrupting the flow of current in or out of the cell. In some embodiments, a PTC device can be used to protect against over current and can also activate when a high temperature is reached. In an over current situation, increased current through the PTC device increases the device temperature and causes the PTC device resistance to increase several orders of magnitude. Thus, temperature can be used to activate the PTC device when a high temperature is reached. This high temperature can result from either an overcurrent through the resistive PTC device or high internal or external temperatures. The PTC device does not totally eliminate the current into or out of the cell; the current is decreased. Typically, PTC devices are not used in applications using high current or high power.

Because various standard lithium-ion cell components (e.g. cases and headers) can be used, cells as disclosed herein may advantageously not require adjustments to manufacturing processes for making the cells of the present embodiments. In addition, the lithium-ion cells disclosed herein may use any type of positive and negative terminal design, with varying components, including but not limited to the use of PTC devices, thin metal tabs, and CID devices, and any methods and materials may be used for components of the cells, including but not limited to any type of tape, any type of welding materials, and any methods of taping and welding. Advantages of using a same or similar process and/or components and/or materials include the reuse of same or similar manufacturing processes and/or equipment. Further, lithium-ion cells of the present disclosure may be assembled (or portions of the assembly may be accomplished) according to any methods known in the art.

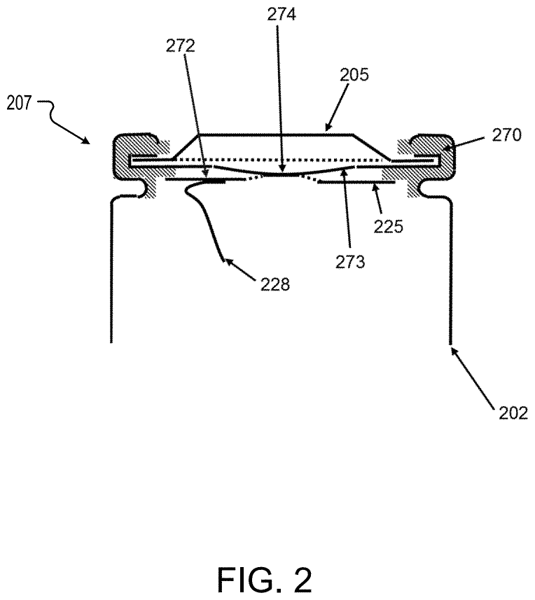

FIG. 2 shows a cross-sectional side view of a header of a cell in accordance with embodiments of the present disclosure. In various embodiments, the description of FIG. 2 relates to FIG. 1 by showing how the can 102 (corresponding to the can 202) is integrated with the header 107 (corresponding to header 207). FIG. 2 shows a top side of a cell, where the top end of the can 202 connects with a header 207 with a gasket 270 between them.

In FIG. 2, the header 207 includes a negative electrode tab 228 (e.g., an end portion of the negative electrode) that is connected to a weld disc 225, a vent disc 273 and a top cap 205. The connection 274 from the weld disc 225 to the vent disc 273 may be by laser welding or resistance welding, for example. A negative electrode tab 228 (e.g., an end portion of the negative electrode) is connected to the weld disc 225 by laser or resistance welding, for example. The header 207 is surrounded by a sealing gasket 270 that electrically separates conductive components of the header from the can 202. Within the gasket, the vent disc 273 is pressed against the top cap 205, thereby providing an electrical connection from the negative electrode tab 228 to the top cap 205. Thus, the top cap 205 is the cover of the cell and the negative terminal of the cell. In some embodiments the top cap 205 is not used and the electrical connection is made directly to the vent disc 273.

In FIG. 2, the header 207 has been crimped onto the can 202 so that the interior components of the cell are fully enclosed within the can 202 and the header 207. The interior of the cell includes a positive electrode (connected to a positive electrode tab (not shown)), a negative electrode (connected to the negative electrode tab 228), separators (not shown), and an electrolyte (not shown). The positive electrode can include a positive electrode active material and a positive electrode current collector having a conductive coating. The negative electrode can include a negative electrode active material and a negative electrode current collector having a conductive coating. The electrolyte may be present within the positive electrode, the negative electrode, and the separators, and may include a lithium compound such that the electrolyte, the positive electrode, and the negative electrode are in ionically conductive contact with each other.

In the embodiments of the cell shown in FIG. 2, the header is at a negative potential because the top cap 205 of the header 207 is electrically connected to the negative electrode tab 228 (e.g., via the laser weld 274 of the negative electrode tab 228 to the weld disc 225). The top cap 205, which is at a negative potential, is electrically isolated from the can 202, which is at a positive potential, by the sealing gasket 270.

In some embodiments, although not shown in FIG. 2, various configurations and components may be used to electrically isolate the electrodes from the interior components of the can. For example, an electrically insulative material (e.g., tape or epoxy) may be adhered on both sides of an exposed portion of the (positive and/or negative) electrode tab adjacent to where the electrode is electrically connected to the header, so that the material ends close to where the electrode is welded (e.g., welded to the header or to the positive electrode). Such an electrically insulative material may be coated onto an exposed portion of the electrode tab adjacent to where the electrode is electrically connected to the header. The electrically insulative material may be any material or combination of materials that is electrically insulative. Other electrically insulative materials that may be used include an insulative polymer disc between the jelly roll and other components. For example, an insulative polymer disc may be positioned to prevent a negative tab from contacting the jelly roll and in particular, the positive electrode.

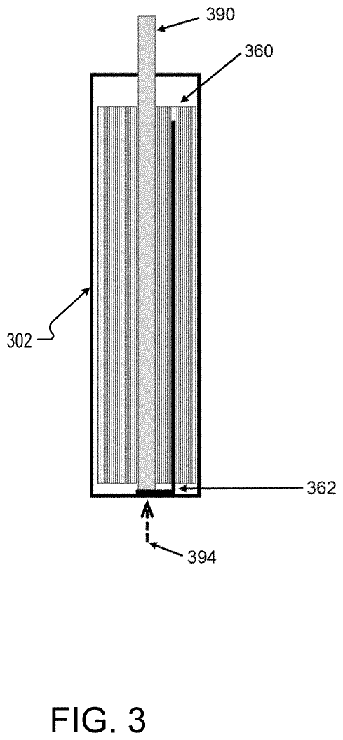

FIG. 3 shows a cross-sectional side view of a method of laser welding components of a cell in accordance with embodiments of the present disclosure. The interior of the cell can have a positive electrode, negative electrode, and one or more of the separators wound into a “jelly roll” form (e.g., jelly roll 360) that is enclosed within the can 302. The “jelly roll” of electrodes can have an outer wrap of separator and/or insulating tape to a positive electrode tab 362 and a negative electrode tab (not shown). In some embodiments, internal tabs (e.g., the positive electrode tab 362 and the negative electrode tab) may be insulated (for example, by tape, a polymer insulator or a coating) from the edge of the corresponding current collector to a few mm from the end of the respective tab. In the case of the negative electrode tab, the insulating prevents the negative electrode internal tab from contacting the positive electrode or the cell can. In the case of the positive electrode tab, the insulating prevents the positive electrode internal tab from contacting the negative electrode. In various embodiments disclosed herein, the components of the cells and the function of the cells may correspond to conventional components and functions as they relate to the jelly roll and header of the cells.

As shown in FIG. 3, the positive electrode tab 362 may be welded to the bottom of the can 302 by a laser weld. Typically, laser welds may be improved when some pressure is applied at the weld position to hold the tab against the can. Thus, a cylindrical tube or rod 390 may be inserted through the middle of the jelly roll 360 to push (from the internal side of the can) the positive electrode tab 362 onto the bottom of the can 302 as a laser is applied to the same location from the other direction (e.g., from the outside of the can, direction 394) to complete the weld. After the laser weld is completed, the rod 390 may be removed from the can, and the remainder of the cell may be assembled as discussed herein.

Assembling the cell can advantageously require minimal changes to conventional manufacturing processes for lithium-ion cells. In some embodiments, use of a can with a variance in thickness may not require any changes to conventional manufacturing processes. Illustrative modifications/additions may include the insulating of one or more of the internal tabs and use of a modified header. Regarding the taping of the negative electrode tab, given that the positive tab in conventional processes is already taped, adding a similar process for the negative tab can advantageously be relatively simple to implement. As discussed herein, the taping is optional, and all other processes could remain the same. In various embodiments, as discussed herein, instead of taping, a coating may be used. For example, an electrically insulative coating may be in contact with the negative electrode tab to prevent the tab from being exposed in areas other than where it is in contact with the case.

The means by which the layers including a complete cell of some embodiments of the present disclosure are assembled into the final working cell are not critical. One skilled in the art will appreciate that a wide diversity of methods for assembling cells, including lithium-ion cells, have been disclosed in the art. For the purposes of some embodiments of the present disclosure, any such methods which are compatible with the particular requisites of given embodiments of the present disclosure are suitable.

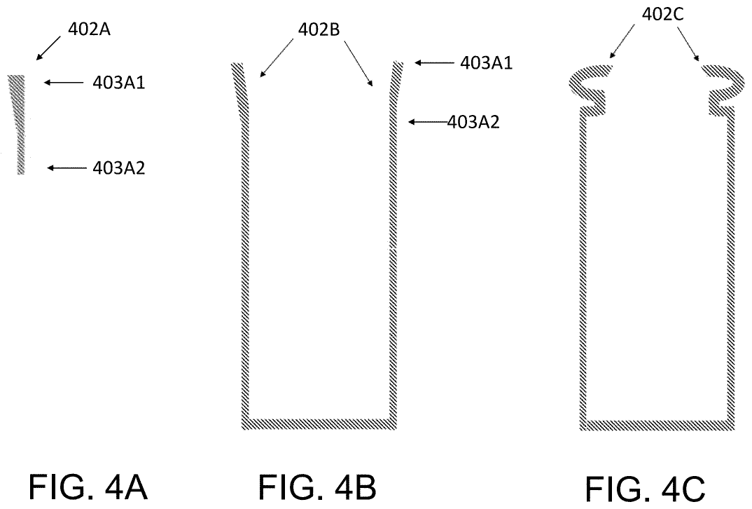

FIG. 4A shows a cross-sectional side view of thicknesses of a top end of a can in accordance with embodiments of the present disclosure. In FIG. 4A, only a top portion of one side of the can 402A is shown that is an illustrative shape of a can prior to cell assembly (e.g., prior to jelly roll insertion, crimping of the can, etc.). The shape of the top of the can 402A can have a greater thickness at the top of the can 403A1 than at a lower portion of the can 403A2. In various embodiments, the increase in thickness can be a gradual and linear slope in thickness with the thickest portion of the can side at the top end of the can 403A1 and with the thickness decreasing as a distance extends below the top end of the can 403A1. The increase in thickness can be present for only a top portion of a can, as shown and discussed in FIG. 4B.

FIG. 4B shows cross-sectional side views of thicknesses of a can in accordance with embodiments of the present disclosure. In FIG. 4B, a shape of the can 402B is shown in a cross-sectional view prior to can assembly (e.g., prior to any connection of the can to a header, crimping of the can, etc.). As shown in FIG. 4B and discussed previously in FIG. 4A, the shape of the can can have a greater thickness along the sides at the top of the can 402B than along the sides at a bottom of the can. This increased thickness may be present for only a top portion of the can (e.g., a top portion of the can between 403A1 and 403A2 that is a portion of the can to be crimped to a header). This provides advantages because the can is a lighter weight from using less materials due to the variance in thickness. The greater thickness on the sides at the top of the can 402B is advantageous because it provides additional strength to the can at portions of the can that require greater strength to reduce the chance of crimp failure (e.g., at a portion of the can that is crimped to the header). The variance in thicknesses shown in FIG. 4B are only exemplary, and other variances in thicknesses may be used in embodiments disclosed herein. For example, there may be an increased thickness at the bottom wall of the cell to reduce any bulging due to increases in internal cell pressure during normal or abnormal operation. Further, the top opening of the can (e.g., at top end 403A1) can have a flare cone like shape where an inner diameter of the top end of the can 403A1 is wider than a lower diameter where the thickness of the can is less. For example, the inner diameter at 403A1 may be greater than an inner diameter at 403A2. The difference in diameter may occur at a linear slope; thus, as shown in FIG. 4B, the wider inner diameter at 403A1 may gradually decrease to the narrower inner diameter at 403A2 that is a same diameter as the remainder of the can below 403A2. The difference in inner diameter may be present together with the differences in thicknesses (e.g., as shown and discussed in FIG. 4A). Such a change in inner diameter may advantageously make jelly roll insertion easier by providing a lead-in chamfer, for example. In various embodiments, the chamfer at the top of the can (e.g., at the opening of the can prior to crimping) may be present independently of any variation(s) in thicknesses.

FIG. 4C shows a cross-sectional side view of crimping of a can in accordance with embodiments of the present disclosure. As shown in FIG. 4C, the sides of the can at the top portion of the can 402C have begun to be crimped to attach a header. FIG. 4C does not show a header or internal components of the can, where an internal electrode tab may be connected to a component of the header prior to beginning the crimping process. However, FIG. 4C shows how a thicker portion of the wall of the can 402C is located at a portion of the wall that is crimped to the header. Advantageously, the thicker portion of the wall of the can 402C provides additional strength at a portion of the wall that is crimped to the header.

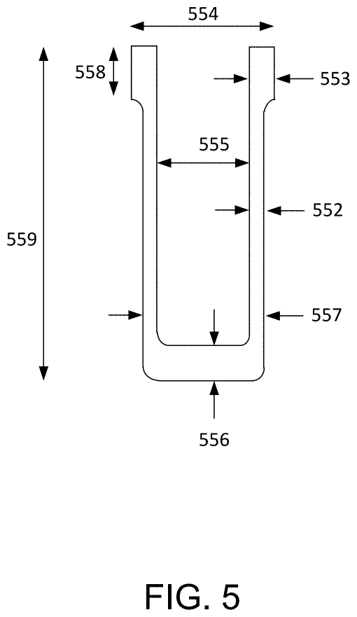

FIG. 5 shows a cross-sectional side view of thicknesses of a can prior to crimping of a can in accordance with embodiments of the present disclosure. In FIG. 5, the can was formed by a multistep ironing process, for example, and then the can was ironed to achieve desired variances in thickness of the walls of the can. In FIG. 5, the can has a height 559, an outer diameter 554, and an inner diameter 555. The can has a thicker portion at the bottom of the can 556, which may advantageously prevent bulging if internal pressure of the can increases. The walls of the can have a thicker portion at the top part of the walls of the can 558. The thicker portion of the top part of the walls of the can 558 has a thickness 553 with the lower walls of the can having a thickness 552. As shown in FIG. 5, the outer diameter 554 at the top of the can is wider than an outer diameter at the bottom of the can 557 because the walls of the can have a variance in thickness (e.g., thickness 553 versus thickness 552); however, the inner diameter 555 of the can is constant and does not change between the thicker portion of the top part of the walls of the can 558 and the lower walls of the can having a thickness 552. As described herein, the can may also have a larger diameter 555 prior to cell crimping at the top of the can compared to the bottom of the can to allow for easier jelly roll insertion.

In various embodiments, a thickness at the bottom of the can (e.g., thickness 556) may be greater than or equal to a thickness at the top portion of the can (e.g., thickness 553), and a thickness at the top portion of the can (e.g., thickness 553) may be greater than a thickness of lower walls of the can (e.g., thickness 552). In some embodiments, a thickness at the bottom of the can (e.g., thickness 556) may be less than a thickness at the top portion of the can (e.g., thickness 553).

In one example, the measurements of the can designed for a cell model 21700 are as follows. The height 559 is about 77.0 mm+/−about 0.2 mm, the outer diameter 557 is about 21.0 mm+/−about 0.1 mm, the height of the thicker portion at the top part of the walls of the can 558 is about 10.0 mm+/−about 0.2 mm, the thickness of the thicker portion at the top part of the walls of the can 558 is about 0.4 mm+/−about 0.02 mm, the thickness of the lower walls of the can 552 is about 0.3 mm+/−about 0.02 mm, and the thickness of the can at the bottom of the can 556 is about 0.5 mm+/−about 0.02 mm. In various embodiments, it is advantageous to have a top wall thickness (e.g., thickness 553) that, after crimping, the crimp of the can over the header will withstand greater than about 23 kgF/cm². Thus, the thickness of the top wall of the can (e.g., thickness 553) may be chosen based on a desired strength of various portions of the can, such as a desired strength of the can at the crimped portion of the can after crimping. In some embodiments, a desired thickness of the top wall of the can (e.g., thickness 553) is about 0.4 mm.

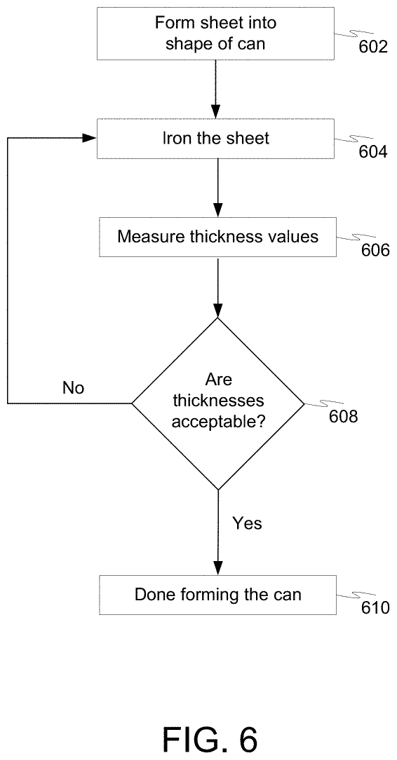

FIG. 6 shows methods for forming aluminum cans with multi-thickness walls in accordance with embodiments of the present disclosure. In FIG. 6, at step 602 a sheet is formed into the shape of a can. This may be done in any manner and may be a multistep drawing process where mechanical pistons are used to apply pressure to the sheet in multiple steps. For example, as the sheet becomes more formed, the piston used to apply pressure can change so that it has a progressively smaller diameter and shape to form the sheet into the desired can shape.

In step 604, the sheet is ironed. The ironing can adjust the thicknesses of walls of the sheet so that they have a desired variance in thickness; for example, the illustrative thicknesses shown and discussed in FIG. 5. In various embodiments, the ironing thickness reduction may be less than an about 20 percent to about 25 percent reduction in thickness of the walls of the can from the original thickness before the ironing. In step 606, the thickness values of the walls of the can are measured, and in step 608 it is determined whether the measured thicknesses are acceptable. This determination of whether the measured thicknesses are desirable may be based on a comparison of the measured thicknesses versus a desired variance in thickness to determine if the measured thicknesses meet the desired variances in thickness (e.g., they are acceptable). If the thicknesses are not acceptable, the method returns to step 604 to continue to iron the sheet. If the thicknesses are acceptable, then the method proceeds to step 610 and the method is done with forming the can. At step 610, a can is produced that has desired variances in thickness and is ready for cell assembly.

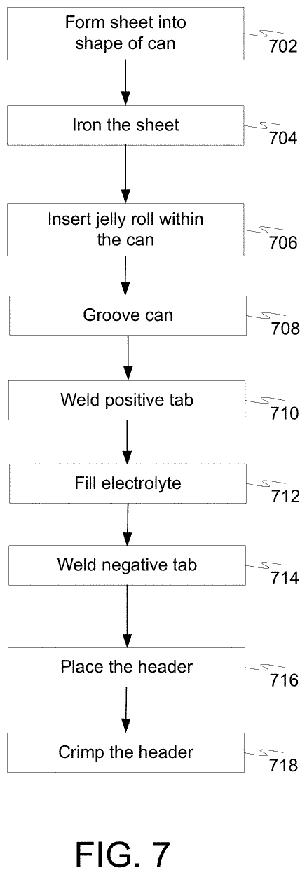

FIG. 7 shows methods of manufacturing lithium-ion cells using aluminum cans with multi-thickness walls in accordance with embodiments of the present disclosure. In step 702, the sheet is formed into the shape of the can, and in step 704, the sheet is ironed. In various embodiments, step 702 may correspond to step 602 in FIG. 6, and step 704 may correspond to steps 604-610 in FIG. 6. After a can is produced that has desired variances in thickness and is ready for cell assembly, in step 706, the jelly roll is inserted within the can. This may be accomplished by any means, and includes rotating the can to be upside down (e.g., rotating the can so that the opening at the top end of the can is inverted and vertically beneath the bottom end of the can) in order to slide the can over the jelly roll (e.g., the jelly roll is inserted through the top opening of the can so that when the jelly roll is fully inserted, then the can is in an upside down position and must be rotated to have the opening vertically above the bottom of the can again).

In step 708, the can is grooved to prepare the can to attach to the header. In various embodiments, the top part of the can that has a greater thickness (e.g., thickness 558 and thickness 553 from FIG. 5) is grooved to form a ledge for the header to sit on. After the ledge is formed, the positive tab is welded to the bottom of the can. The positive tab may be connected to the can in any manner and the positive tab may be welded as discussed in relation to FIG. 3. For example, a cylindrical rod may be inserted through the middle of the jelly roll to push (from the internal side of the can) the positive electrode tab onto the bottom of the can as a laser is applied to the corresponding location of the connection of the positive tab at the bottom of the can from the other direction (e.g., from the outside of the can) to complete the weld. After the laser weld is completed, the rod is removed from the can.

In step 712, electrolyte is filled inside the can. In step 714, the negative tab is welded to the weld plate in the header in step 710. At this point, although the header is attached to the positive tab, the header is not crimped onto the can, it is only resting on the ledge formed at the thick part of the top of the can so that it may be removed a short distance (e.g., as far as is necessary to weld the connection of the positive electrode to the header). After the negative tab is welded to the header, in step 716 the header may be placed on the ledge created in step 708 to prepare for the header to be crimped to the can. In step 718, the header is crimped to the can. In various embodiments, the crimping may be a progressive type of crimp process where the top section of the can (e.g., thickness 558 and thickness 553 from FIG. 5) is formed around a polymer gasket in the header. The polymer gasket prevents physical, electrical contact between the can and the header, which are at opposite potentials.

The exemplary systems and methods of this disclosure have been described in relation to a battery module 100 and a number of battery cells 208 in an electric vehicle energy storage system. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others. In some embodiments, the present disclosure provides an electrical interconnection device that can be used between any electrical source and destination. While the present disclosure describes connections between battery modules and corresponding management systems, embodiments of the present disclosure should not be so limited.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include an electrochemical cell, comprising: a positive electrode comprising a positive electrode active material in electrically conductive contact with a positive electrode current collector; a negative electrode comprising a negative electrode active material in electrically conductive contact with a negative electrode current collector; an electrically insulative and ion conductive medium in ionically conductive contact with the positive electrode and the negative electrode, wherein the electrically insulative and ion conductive medium comprises an electrically insulating porous layer and an electrolyte; and an outer can containing the positive electrode, the negative electrode and the electrically insulative and ion conductive medium, wherein a wall of the outer can has a variance in thickness.

Aspects of the electrochemical cell include wherein the negative electrode is electrically connected to a header of the electrochemical cell. Aspects of the electrochemical cell include wherein the outer can comprises substantially a metal composition comprising one or more of aluminum or an alloy thereof and titanium or an alloy thereof. Aspects of the electrochemical cell include wherein the variance in thickness comprises a thicker portion of the outer can at a portion of the wall that is adjacent to the header. Aspects of the electrochemical cell include wherein a top part of the outer can is crimped to the header, and wherein a thickness of the top part of the outer can and a thickness of a bottom part of the outer can are each greater than a thickness of a middle part of the outer can. Aspects of the electrochemical cell include wherein an inner diameter of the top part of the outer can is substantially the same as each of an inner diameter of the middle part of the outer can and an inner diameter of the bottom part of the outer can. Aspects of the electrochemical cell include wherein the variance in thickness is based on a desired strength of a crimp between the outer can and the header. Aspects of the electrochemical cell include wherein the outer can is electrically connected to the positive electrode. Aspects of the electrochemical cell include wherein an electrically insulative tape is adhered on both sides of an exposed portion of the negative electrode tab adjacent to where the negative electrode is electrically connected to the header. Aspects of the electrochemical cell include wherein an electrically insulative coating is in contact with an exposed portion of the negative electrode tab adjacent to where the negative electrode is electrically connected to the header. Aspects of the electrochemical cell include wherein the electrically insulative material is an epoxy coating.

Aspects of the electrochemical cell include wherein the outer can comprises substantially a metal composition having a density less than steel. Aspects of the electrochemical cell include wherein the variance in thickness comprises a thicker portion of the outer can at a portion of the wall that is adjacent to the header. Aspects of the electrochemical cell include wherein the variance in thickness comprises a thicker portion of the outer can at a bottom end of the outer can. Aspects of the electrochemical cell include wherein an inner diameter of the top part of the outer can is substantially the same as each of an inner diameter of the middle part of the outer can and an inner diameter of the bottom end of the outer can. Aspects of the electrochemical cell include wherein an inner diameter of the top end of the outer can is larger than an inner diameter of a lower part of the outer can. Aspects of the electrochemical cell include wherein the top part of the outer can is chamfered. Aspects of the electrochemical cell include wherein the outer can is electrically connected to the positive electrode through the positive electrode tab. Aspects of the electrochemical cell include wherein the negative electrode tab is electrically insulated adjacent to where the negative electrode is electrically connected to the header. Aspects of the electrochemical cell further include an electrically insulative polymer disc between the jelly roll and the header.

Embodiments include a method of manufacturing an electrochemical cell, comprising: forming a positive electrode comprising a positive electrode active material in electrically conductive contact with a positive electrode current collector; forming a negative electrode comprising a negative electrode active material in electrically conductive contact with a negative electrode current collector; inserting the positive electrode, the negative electrode, and an electrically insulative and ion conductive medium into an outer can, wherein the electrically insulative and ion conductive medium comprises an electrically insulating porous layer and an electrolyte, wherein the electrically insulative and ion conductive medium is in ionically conductive contact with the positive electrode and the negative electrode, and wherein a wall of the outer can has a variance in thickness, and crimping the outer can to a header.

Aspects of the method further include ironing the wall of the outer can to obtain the variance in thickness prior to the inserting the positive electrode, the negative electrode, and the electrically insulative and ion conductive medium. Aspects of the method include wherein the variance in thickness comprises a middle part of the outer can that has a wall thickness that is thinner than each of a wall thickness of a top part of the outer can that is crimped to the header and a thickness of a bottom part of the outer can. Aspects of the method include wherein an inner diameter of the top part of the outer can is substantially the same or slightly larger than the inner diameter of each of a middle part and a bottom part of the outer can. Aspects of the method include wherein the variance in thickness is based on a desired strength of a crimp obtained by the crimping of the outer can to the header. Aspects of the method further include electrically connecting the negative electrode to the header. Aspects of the method include wherein the outer can comprises substantially a metal composition comprising one or more of aluminum or an alloy thereof and titanium or an alloy thereof. Aspects of the method include wherein the variance in thickness comprises a middle and lower part of the outer can that has a wall thickness that is thinner than each of a wall thickness of a top part of the outer can that is crimped to the header and a thickness of a bottom end of the outer can. Aspects of the method include wherein an inner diameter of the top part of the outer can is substantially the same as an inner diameter of each of a middle part and a lower part of the outer can. Aspects of the method further include electrically connecting the negative electrode to the header and electrically connecting the positive electrode to a bottom of the outer can using a cylindrical rod pushing a positive electrode tab onto an internal surface of the bottom end of the outer can while applying a laser to a corresponding location on an external surface of the bottom end of the outer can to physically connect the tab and can.

Embodiments include a battery for an electric vehicle, comprising: a plurality of battery modules electrically interconnected with one another, wherein each battery module of the plurality of battery modules comprises: a plurality of energy storage cells, each of the energy storage cells comprising: a positive electrode comprising a positive electrode active material in electrically conductive contact with a positive electrode current collector; a negative electrode comprising a negative electrode active material in electrically conductive contact with a negative electrode current collector; an electrically insulative and ion conductive medium in ionically conductive contact with the positive electrode and the negative electrode, wherein the electrically insulative and ion conductive medium comprises an electrically insulating porous layer and an electrolyte; and an outer can containing the positive electrode, the negative electrode and the electrically insulative and ion conductive medium, wherein a wall of the outer can has a variance in thickness.

Any one or more of the aspects/embodiments as substantially disclosed herein.

Any one or more of the aspects/embodiments as substantially disclosed herein optionally in combination with any one or more other aspects/embodiments as substantially disclosed herein.

One or more means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, microcode, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The term “chemical properties” refer to one or more of chemical composition, oxidation, flammability, heat of combustion, enthalpy of formation, and chemical stability under specific conditions.

The terms “determine,” “calculate,” “compute,” and variations thereof, as used herein, are used interchangeably and include any type of methodology, process, mathematical operation or technique.

The term “thermal properties” refer to one or more of thermal conductivity, thermal diffusivity, specific heat, thermal expansion coefficient, and creep resistance.

The terms “electrical insulator” and “electrically insulative” refers to a material or combination of materials whose internal electrical charges do not flow freely; very little electric current will flow through the material(s) under the influence of an electric field. Electrical insulators have higher resistivity than semiconductors or conductors. The electrical insulator material(s) may be natural or synthetic.

What is claimed is:

1. An electrochemical cell, comprising:
a positive electrode comprising a positive electrode active material in electrically conductive contact with a positive electrode current collector;
a negative electrode comprising a negative electrode active material in electrically conductive contact with a negative electrode current collector;
an electrically insulative and ion conductive medium in ionically conductive contact with the positive electrode and the negative electrode, wherein the electrically insulative and ion conductive medium comprises an electrically insulating porous layer and an electrolyte; and
an outer can containing the positive electrode, the negative electrode and the electrically insulative and ion conductive medium, wherein a wall of the outer can has a variance in thickness.

2. The electrochemical cell of claim 1, wherein the negative electrode is electrically connected to a header.

3. The electrochemical cell of claim 1, wherein the outer can comprises substantially a metal composition having a density less than steel.

4. The electrochemical cell of claim 1, wherein the variance in thickness comprises a thicker portion of the outer can at a portion of the wall that is adjacent to the header.

5. The electrochemical cell of claim 2, wherein the variance in thickness comprises a thicker portion of the outer can at a bottom end of the outer can.

6. The electrochemical cell of claim 5, wherein an inner diameter of the top part of the outer can is substantially the same as each of an inner diameter of the middle part of the outer can and an inner diameter of the bottom part of the outer can.

7. The electrochemical cell of claim 5, wherein an inner diameter of the top part of the outer can is larger than an inner diameter of a lower part of the outer can.

8. The electrochemical cell of claim 5, wherein the top part of the outer can is chamfered.

9. The electrochemical cell of claim 2, wherein the variance in thickness is based on a desired strength of a crimp between the outer can and the header.

10. The electrochemical cell of claim 2, wherein the outer can is electrically connected to the positive electrode through the positive electrode tab.

11. The electrochemical cell of claim 1, wherein the negative electrode tab is electrically insulated adjacent to where the negative electrode is electrically connected to the header.

12. The electrochemical cell of claim 11, further comprising an electrically insulative polymer disc between the jelly roll and the header and negative tab.

13. A method of manufacturing an electrochemical cell, comprising:
forming a positive electrode comprising a positive electrode active material in electrically conductive contact with a positive electrode current collector;
forming a negative electrode comprising a negative electrode active material in electrically conductive contact with a negative electrode current collector;
inserting the positive electrode, the negative electrode, and an electrically insulative and ion conductive medium into an outer can,
wherein the electrically insulative and ion conductive medium comprises an electrically insulating porous layer and an electrolyte,
wherein the electrically insulative and ion conductive medium is in ionically conductive contact with the positive electrode and the negative electrode, and
wherein a wall of the outer can has a variance in thickness in the region used in crimping the outer can to a header.

14. The method of manufacturing the electrochemical cell of claim 13, further comprising ironing the wall of the outer can to obtain the variance in thickness prior to the inserting the positive electrode, the negative electrode, and the electrically insulative and ion conductive medium.

15. The method of manufacturing the electrochemical cell of claim 13, wherein the variance in thickness comprises a middle and lower part of the outer can that has a wall thickness that is thinner than each of a wall thickness of a top part of the outer can that is crimped to the header and a thickness of a bottom part of the outer can.

16. The method of manufacturing the electrochemical cell of claim 15, wherein an inner diameter of the top part of the outer can is substantially the same as an inner diameter of each of a middle part and a lower part of the outer can.

17. The method of manufacturing the electrochemical cell of claim 15, wherein the top part of the outer can is chamfered.

18. The method of manufacturing the electrochemical cell of claim 13, further comprising, electrically connecting the negative electrode to the header and electrically connecting the positive electrode to a bottom of the outer can using a cylindrical rod pushing a positive electrode tab onto an internal surface of the bottom end of the outer can while applying a laser to a corresponding location on an external surface of the bottom end of the outer can.

19. The method of manufacturing the electrochemical cell of claim 13, wherein the outer can comprises substantially a metal composition comprising one or more of aluminum or an alloy thereof and titanium or an alloy thereof.

20. A battery for an electric vehicle, comprising:
a plurality of battery modules electrically interconnected with one another, wherein each battery module of the plurality of battery modules comprises:
a plurality of energy storage cells, each of the energy storage cells comprising:
a positive electrode comprising a positive electrode active material in electrically conductive contact with a positive electrode current collector;
a negative electrode comprising a negative electrode active material in electrically conductive contact with a negative electrode current collector;
an electrically insulative and ion conductive medium in ionically conductive contact with the positive electrode and the negative electrode, wherein the electrically insulative and ion conductive medium comprises an electrically insulating porous layer and an electrolyte; and
an outer can containing the positive electrode, the negative electrode and the electrically insulative and ion conductive medium, wherein a wall of the outer can has a variance in thickness.
